(19) United States
(12) Patent Application Publication
(10) Pub. No.: US 2005/0254689 A1
(43) Pub. Date: Nov. 17, 2005

(54) Method for controlling access to a sensitive area, particularly a transport device, by biometric verification

(75) Inventor: Jacques Bouillon, Maurepas (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: I.E.R., Suresnes (FR)

(21) Appl. No.: 10/502,292

(22) PCT Filed: Jan. 23, 2003
(86) PCT No.: PCT/FR03/00221

§ 371 Date: Apr. 12, 2005

(30) Foreign Application Priority Data
Jan. 23, 2002 (FR) 0200808

(51) Int. Cl. G06K 19/00

(52) U.S. Cl. 382/115; 340/5.52; 235/382

(57) ABSTRACT

A method of access control to a secure area that comprises obtaining a first biometric reading at a first station from a person seeking to access the secure area; recording the first biometric reading on a card as biometric data; returning the card having biometric data to the person; providing a means for reading the biometric reading at a second station located at the secure area; obtaining a second biometric reading from the person; and comparing the biometric data on the card with the second biometric reading to ensure that the person giving the second biometric reading is the same person giving the first biometric reading.

### CROSS REFERENCE TO RELATED APPLICATIONS

The present application is the National Stage of International Application No. PCT/FR03/00221, filed on Jan. 23, 2003, which claims the benefit of French Application No. 02-00808, filed on Jan. 23, 2003.

### BACKGROUND OF THE INVENTION

The invention relates to access control to secure areas, particularly transport vehicles, and more particularly access control for boarding aircraft.

However, the invention is not limited to this particular transport application. It covers access control to all secure areas, for example such as access to secure rooms or parameters, secure companies, particularly banks, official organisations, particularly ministries, sports stadiums, etc.

And particularly in the context of accesses for boarding aircraft, it is particularly important nowadays to make sure that preliminary identity checks before boarding will not be bypassed.

In particular, it has become routine procedure to carry out several identity checks on the same person before allowing access onboard.

Thus, it is quite normal to check the passport of a person at the time that luggage is checked in, in other words when he is issued with his boarding card, and then to check the passport again when “reading at the boarding gate”, in other words at the time of boarding, by electronically reading the boarding card. The passenger is then obliged to board the aircraft.

This double check is expensive for airline companies.

### SUMMARY OF THE INVENTION

The purpose of the invention is to satisfy a need for increasing the reliability and for reducing the costs of access controls made when boarding transport vehicles.

The invention achieves this purpose using a method of access control to a secure area, particularly to a transport vehicle, in which a person who would like to access the secure area is asked for personal data, these personal data are written on a card after they have been coded, this card is issued for the attention of this person and then at the time of access to the secure area, the personal data supplied by the person presenting this card are compared with the personal data written on the card to ensure that this person is actually the person authorised to use this card, characterised in that it includes two steps in which biometric readings are made directly on the person, one before the card is issued and the other at the access to the secure area, the recorded biometric data before the card is issued forming data written and coded on the card, the biometric data recorded at the access to this secure area being compared with the data on the card.

The invention also proposes an automatic access control module to a secure area, particularly a transport vehicle, comprising means of automatically reading data recorded on an access card to the secure area, characterised in that these read means are designed to read biometric data registered on the card, and in that the module also comprises a sensor for sampling biometric data on a person and means of automatically comparing biometric data read on the card with data recorded by the sensor.

The invention also proposes a set of access control means to a secure area, particularly to a transport vehicle, comprising means of writing data onto cards controlling access to the secure area on a first site, and means of automatically reading these cards controlling access to the secure area on a second site, characterised in that the means on the first site also include a sensor for sampling biometric data on a person and means of writing these data on a card controlling access to the secure area, and in that the means on the second site comprise automatic means of reading biometric data written on the card, a sensor for sampling biometric data on a person, and means of making an automatic comparison between the biometric data read on the card and the data read by this sensor, these comparison means being designed to indicate if the data on the card and the data on the sensor belong to the same person.

Other characteristics, purposes and advantages of the invention will become clear after reading the detailed description given below with reference to the attached figure which shows an access control assembly according to a preferred variant of the invention.

### DETAILED DESCRIPTION OF THE DRAWINGS

The following description is related to the special case of access control when boarding a transport means, particularly an aircraft. However, the invention is not limited to this particular application. It includes access control to all secure areas, as mentioned above.

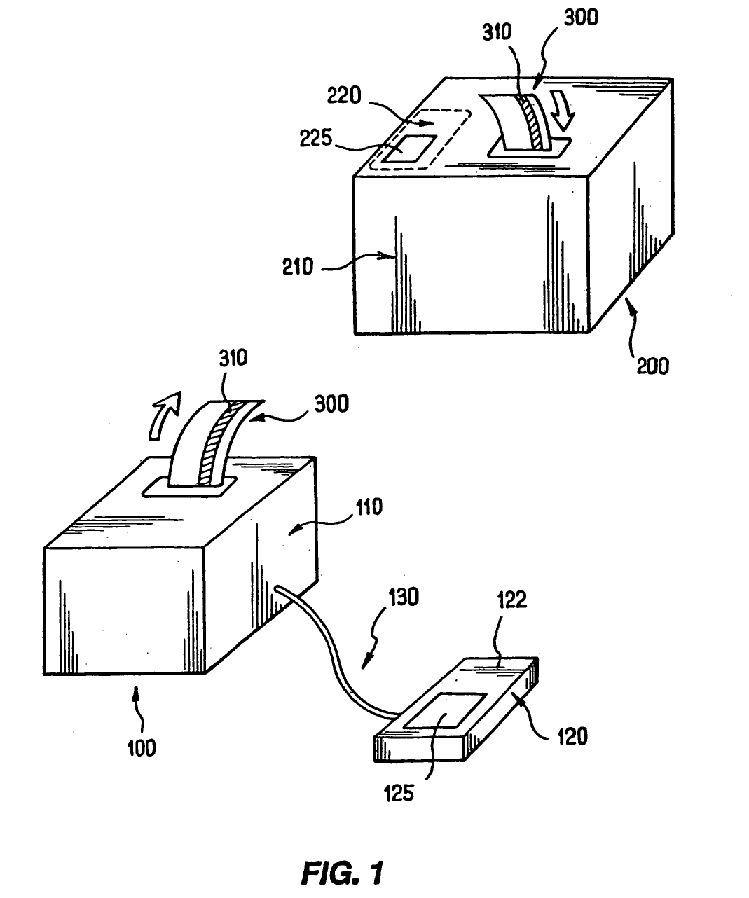

The means in FIG. 1 are distributed in two modules, in other words a module 100 for printing the onboard access card and a module 200 for reading such a card at a boarding gate. This second module is normally called the “boarding gate reader”.

The module 100 comprises mainly a printer 110 designed particularly to print boarding cards. An example of a boarding card is shown in FIG. 1 as reference 300.

Apart from the fact that it includes means of printing text visible on such a card 300, this printer 110 has means of writing data on the card that are non-legible to the naked eye and that will be read by a machine. In this case, these means of writing data are memory means acting on a magnetic strip 310 on the card.

The module 100 also comprises an electronic fingerprint sensor 120. In the figure, this sensor is represented in the form of an independent housing 122 connected to the printer 110 through a wire link 130.

This housing 122 is provided with a secure area 125 in which one or more fingers are placed to record a fingerprint. Then, this type of record is sent by the sensor 120 to the printer 110 in the form of a digital file.

The printer 110 comprises a means of retranscribing the fingerprint data thus received onto the magnetic strip 310. A fingerprint is captured and recorded on the strip 310 in the form of a computer file.

The form of the reader module 200 at the boarding gate is similar to the module already described.

It also has a block 210 designed to interact with the magnetic strip 310 of the card 300, and a fingerprint sensor 220. This sensor 220 is integrated into the block 210 if possible, such that its secure area 225 is flush with the top surface of the block 210.

The objective of this module 200 is to acquire data written on the magnetic strip 310 of a card 300.

The module achieves this by including magnetic means for reading this strip 310.

This read module 200 also includes a processor in liaison with magnetic read means and with the fingerprint sensor 220. Therefore, the processor receives firstly fingerprint data read on the magnetic strip 310 of the card and secondly fingerprint data captured on a person by the sensor 220.

This processor then compares the two groups of data thus received in order to identify whether or not the fingerprint input by the sensor 220 and the fingerprint read on the card 300 are similar.

In an airport, these two modules 100 and 200 are preferably positioned as described below:

The module 100 is placed at a “check-in” desk, in other words a counter at which a passenger presents his ticket and luggage, if any, which are then transported towards the aircraft on a conveyor belt.

This type of check-in desk on which the module 100 is installed, is also the preferred location for an identity check before the card is printed.

The module 200 is placed at a final barrier before access to the aircraft, typically at the entrance to an aircraft access gateway.

By comparing the card carrier's fingerprint with the print recorded on the card, the second module 200 automatically checks that the card is used by the authorised person. This check is reliable, since it is based on electronic reading of fingerprints, which is technically very reliable.

The boarding card 300 contains data that are inevitably related to the person who already presented himself at the check-in desk, and his identity has been checked on his passport at the check-in desk.

Thus, if the person checks in at the check-in desk and is then substituted by another person who presents himself with the boarding card issued to the first person, this substitution will be detected immediately. Only the first person, and therefore the person whose identification has been verified, can use the card.

Therefore, it is no longer necessary to make a new identity check with reference to the passport when boarding, since the system automatically guarantees that the card carrier is the same person who checked in at the check-in desk. Therefore, a single identity check when the boarding card is printed is sufficient to ensure that the person boarding the plane has already provided his identity data, and has already been authorised.

Thus, with this access control system, the effects of the initial identity check continue until boarding, as a result of electronic tracking of the person by a ticket biometrically related to the person.

Furthermore with this system, the biometric data used may be recorded only on the card 300 and on no other computer medium, for example a database. Thus, the passenger is assured that his fingerprint record is only kept on the flexible cardboard boarding card, that he can subsequently destroy.

Thus with this system, the extended use of biometric data for a passenger can be used, without contravening any regulations about keeping customer personal data.

More generally, the unpleasant aspect of taking a fingerprint, as is done when making a police record, is minimised by the guarantee that a person's fingerprints will not be kept.

The example embodiment described in this document is given as a preferred example.

However, there are other examples of embodiments of the invention that also have many advantages.

The example described above relates to a procedure for access to the secure area, including the step in which biometric data are written on the card, and also the effective use of this card, at the entry to the secure area.

In particular, in one procedure performed at the entry to the secure area, in which the card is written and used at the entry to the secure area, it is proposed to use a card other than a boarding card, for example a plastic card the same size as a credit card.

This type of cards is particularly advantageous due to the memory capacity of their magnetic strip. They are also advantageous when they contain a chip, also due to the chip storage capacity.

The card may perform other functions, such as an identity card or a “frequent flyer” type card, in other words a loyalty card incorporating a measurement of the frequent use of the airline company made by the card carrier.

The card may also be used to enable access to other secure premises. The card can thus be an access card to company premises.

These various cards may be issued on entry to the secure area for the first time, in the step in which they are written. As a variant, the user supplies the card (for example a “frequent flyer” card) in which the biometric data input by the user are written close to the secure area, before being used for effective entry into the secure area.

The use of a magnetic record to write on the card as proposed in this description is not the only variant.

Thus, a biometric data record in the form of bar codes could be adopted rather than a record on a magnetic strip, or other means of entering biometric data that can be read by a machine could be used.

Preferably, data are written on the card so that a person cannot read them, and preferably they should be non-graphic, in other words so that a person cannot see the shapes, to avoid the possibility of fraud by graphic copy using a photocopier.

The invention has been described herein with reference to taking fingerprints. Other biometric records may be made using sensors, such as a record of parameters for the eye, and particularly the iris, and/or the person's voice recorded by a microphone and a sound analysis.

In another variant, the biometric data measured on the person consists of the geometry of the hand.

In yet another variant, the geometry of the face as captured by a camera is used as the biometric data, once again before the ticket is issued and then close to the aircraft.

According to another variant, the means of recording biometric data conform with the invention may be coupled to a database, to be input into this database.

1-16. (canceled)

17. A method of access control to a secure area comprising:
obtaining a first biometric reading at a first station from a person seeking access to the secure area;
recording said first biometric reading on a card as biometric data;
providing a means for reading the biometric data on said card at a second station located at the secure area;
obtaining a second biometric reading from the person; and
comparing the biometric data on the card with the second biometric reading to ensure that the person giving the second biometric reading is the same person giving the first biometric reading.

18. the method according to claim 17, wherein the card having biometric data is returned to the person after obtaining the first biometric reading.

19. The method according to claim 17, wherein the card having biometric data is retained by a security personnel.

20. The method according to claim 17, wherein a non-graphic method is used to compare the second biometric reading with the biometric data recorded on the card.

21. The method according to claim 17, wherein the card comprises a magnetic strip and a memory means for recording the biometric data on the magnetic strip of the card.

22. The method according to claim 17, wherein an identity document is used to conduct an identity check on the person at the same time the biometric reading is obtained from the person.

23. The method according to claim 17, further comprising using a computing means to compare said first and second biometric readings.

24. The method according to claim 17, wherein the biometric data comprises at least one fingerprint of the person.

25. The method according to claim 17, wherein the biometric data comprises data about the eye of the person.

26. The method according to claim 17, wherein the biometric data comprises data about voice parameters of the person.

27. The method according to claim 17, wherein the biometric data comprises geometric parameters of the face of the person.

28. The method according to claim 17, wherein the biometric data comprises geometric parameters of the person's hand.

29. The method according to claim 17, wherein the card is a supple boarding pass.

30. The method according to claim 29, wherein the card is comprised of a material that can be torn off by the person, so that the person may easily destroy the biometric data on the card.

31. The method according to claim 17, wherein the card is comprised of a plastic material.

32. The method according to claim 17, wherein the second station comprises a check-in desk provided with routing means of routing luggage to the secure area; automatic means for obtaining a second biometric reading from a person; and means for recording the second biometric reading on a card as comparison biometric data, so that the first biometric reading is conducted at the same time as the person's luggage is checked in.

33. The method according to claim 17, wherein the second station includes an access gate to the secure area, a reading desk comprising a module for automatically reading biometric data written on the card of the person wishing to access the secure area, a biometric sensor, and means for automatically comparing the second biometric reading recorded by the sensor on the person with biometric data written on the card.

34. A module for an automatic access control to a transport vehicle, comprising:
reading means for automatically reading data recorded on an access card, the reading means reading biometric data recorded on the access card in the form of text;
a sensor for sampling biometric data on a person; and
comparison means for automatically comparing biometric data on the card with data recorded by the sensor, the comparison means capable of indicating that data on the access card and data provided by the sensor belong to a same person.

35. An access control assembly for permitting access to a secure area, comprising:
writing means for writing data onto a card controlling access to the secure area at a first site, and
reading means for automatically reading the card at a second site,
the writing means including a first sensor for sampling biometric data on a person, and
the reading means including automatic means for reading biometric data written on the cards; a second sensor for sampling biometric data from a person; and comparison means for making an automatic comparison between the biometric data read on the card and the data read by the sensor, the comparison means capable of indicating if the data on the card and the data on the sensor belong to the same person.

36. The assembly according to claim 35 wherein the writing means at the first site is at least a partially non-graphic method.
